(19) United States
(12) Patent Application Publication
(10) Pub. No.: US 2002/0096011 A1
(43) Pub. Date: Jul. 25, 2002

(54) Adjustable pedal system with pedal step over retention

(76) Inventors: David Joseph Chapman, Sterling Heights, MI (US); Waldemar Wawrzyniec Gmurowski, Sterling Heights, MI (US)

Correspondence Address: PATRICK M. GRIFFIN, DELPHI TECHNOLOGIES, INC., Legal Staff, Mail Code: 480-414-420, P.O. Box 5052, Troy, MI, 48007-5052, US

(21) Appl. No.: 09/848,400

(22) Filed: May 3, 2001

Related U.S. Application Data
(63) Continuation-in-part of application No. 09/640,384, filed on Aug. 16, 2000.
(60) Provisional application No. 60/155,826, filed on Sep. 21, 1999.

(51) Int. Cl. G05G 1/14

(52) U.S. Cl. 74/512

(57) ABSTRACT

An adjustable pedal system has a first pedal pivotally attached to the translatable nut of a first jack screw actuator for adjusting the fore and aft position of the first pedal and a second pedal pivotally attached to the translatable nut of a second jack screw actuator for adjusting the fore and aft position of the second pedal. An electric motor is drivingly connected to the first jack screw actuator and the second jack screw actuator to drive the translatable nuts fore and aft. The fore and aft alignment of the first pedal with respect to the second pedal is maintained by a switch assembly that is mechanically connected to the translatable nuts of the two jack screw actuators.

### FIELD OF THE INVENTION

This invention relates to an adjustable pedal system for an automobile.

### BACKGROUND OF THE INVENTION

Adjustable pedal systems are known in the art. These adjustable pedal systems allow the driver to adjust the position of the brake and accelerator pedals (and clutch pedal in automobiles with manual transmissions) fore and aft for greater comfort and for greater distance from a steering wheel mounted air bag.

These adjustable pedal systems often comprise a jack screw actuator for each adjustable pedal and in some instances the rotary screws, also known as threaded members, of several jack screw actuators are rotated by a common power source, such as an electric motor. See for instance, U.S. Pat. No. 4,870,871 granted to Steve D. Ivan Oct. 3, 1989; U.S. Pat. No. 5,460,061 granted to Harry L. Redding et al Oct. 24, 1995 and U.S. Pat. No. 5,722,302 granted to Christopher J. Rixon et al Mar. 3, 1998.

The Redding '061 patent and the Rixon '302 patent both disclose arrangements that have two flexible, torsionally rigid cables that transfer drive from a single power source, an electric motor, to two jack screws, each of which adjusts a different pedal. A drawback of these adjustable pedals system is that one pedal can be adjusted white the other pedal remains stationary if one of the power transfer cables breaks. This results in pedal misalignment which in turn may result in an awkward and uncomfortable operation for the vehicle driver.

### SUMMARY OF THE INVENTION

The adjustable pedal system of this invention uses a single electric motor that drives a plurality of jack screw actuators with flexible, but torsionally rigid, cables. Each pedal is driven by one of the jack screw actuators that is driven by one of the cables. An aligned fore—aft location of the various pedals, such as the accelerator pedal and the brake pedal (i.e. pedal step-over) must be maintained within certain desirable limits. The adjustable pedal system of the invention maintains the fore-aft alignment of the various pedals by controlling the electric motor with a switch that is mechanically connected to the adjustable pedals; the switch being operated when the adjustable pedals are out of alignment to de-energize the electric motor. This feature prevents pedal misalignment during the adjustment process even if one of the drive cables breaks so that one of the pedals is not moved by its associated jack screw actuator during the adjustment process.

### BRIEF DESCRIPTION OF THE DRAWINGS

The presently preferred embodiment of the invention is disclosed in the following description and in the accompanying drawings, wherein:

FIG. 1 is a schematic plan view of an adjustable pedal system in accordance with the invention;

FIG. 2 is a sectional side view of a switch component of the adjustable pedal system that is shown in FIG. 1;

FIG. 3 is a partial sectional top view of the switch component that is shown in FIG. 2; and

FIG. 4 is a schematic view of the motor control circuit including the switch component that is shown in FIGS. 2 and 3.

### DETAILED DESCRIPTION OF PREFERRED EMBODIMENT

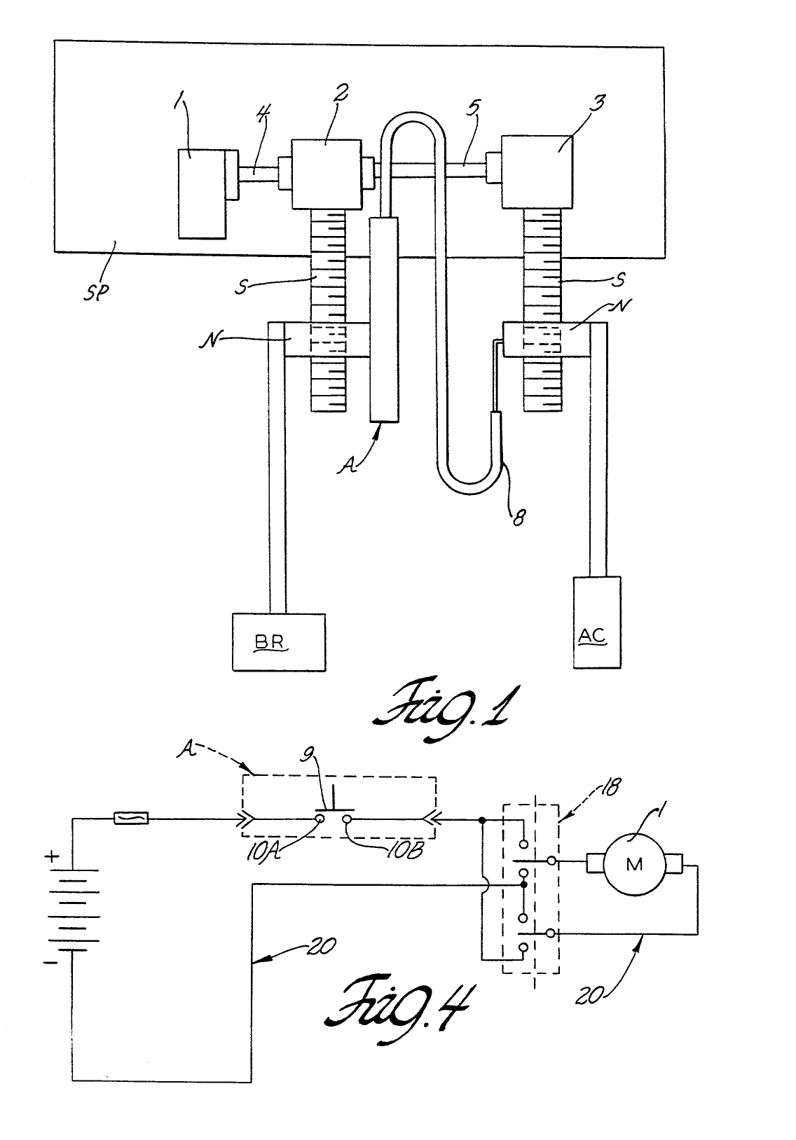

Referring now to the drawing, FIG. 1 shows an adjustable pedal system comprising an accelerator pedal AC and a brake pedal BR which are commonly used in all automobiles. These pedals control the engine throttle and the vehicle brakes through suitable linkages that are not shown because any suitable linkage may be used. The system may include a clutch pedal (not shown) which is commonly used in an automobile with a manual transmission. The pedals in turn are all controlled by foot and leg movements of the vehicle driver. The positioning of the pedals with respect to the driver is important to the comfort of the driver. The adjustable pedal system allows the driver to position the pedals fore and aft for greater comfort and for greater distance from a steering wheel mounted air bag.

Pedal adjustment in the system of the invention is done by a single electric motor 1 that drives jack screw actuators 2 and 3 with flexible, but torsionally rigid, cables 4 and 5 as shown in FIG. 1. Motor 1 and jack screw operators 2 and 3 are mounted on a support SP that may be part of a vehicle body or a bracket attached to the vehicle body. Each pedal is adjusted by one of the jack screw actuators which is turn is driven by at least one of the flexible cables. For instance, brake pedal BR is adjusted by jack screw actuator 2 which in turn is driven by cable 4 which in turn is preferably driven directly by motor 1. On the other hand, accelerator pedal AC is adjusted by jack screw actuator 3 which is driven by cable 5 which in turn is indirectly driven by motor 1 via actuator 2 and cable 4. Motor 1 could be replaced by a motor having a drive shaft at each end and repositioned between actuators 2 and 3 thereby shortening the drive line to actuator 3 to a direct drive from motor 1. In any event, each pedal is driven by its own actuator that in turn is driven by at least one cable.

Jack screw actuators are well know in the art and need not be described in detail. Suffice it to state that each jack screw actuator has a nut N that is translated fore or aft with respect to the screw when the screw S is rotated one way or the other. Pedals BR and AC are pivotally mounted on the nuts N of the respective jack screw actuators 2 and 3 so that the two pedals move fore or aft in unison when jack screw actuators 2 and 3 are driven by the common electric motor 1. Pedal BR is operatively connected to the brake system of the automobile (not shown) so that pedal BR operates the brake system is response to pivotal motion with respect to nut N of jack screw actuator 2 regardless of the fore or aft position of the nut N. Similarly pedal AC is operatively connected to the throttle mechanism of the automobile engine (not shown) so that pedal AC operates the throttle mechanism in response to pivotal motion with respect to nut N of jack screw actuator 3 regardless of the fore or aft position of nut N.

As indicated above, the fore-aft alignment of the various pedals (pedal step-over) must be maintained within certain desirable limits. It is conceivable that the flexible cable 5 could break. If this occurred, brake pedal BR could move fore or aft during the adjustment process while accelerator pedal AC remained stationery.

The adjustable pedal system of the invention maintains the fore-aft alignment of the two pedals by controlling the electric motor 1 with a normally closed switch that is mechanically connected to the adjustable pedals; the switch being opened when the adjustable pedals are out of alignment to de-energize the electric motor 1. This feature prevents pedal misalignment during the adjustment process even if drive cable 5 breaks so that accelerator pedal AC is not moved by jack screw actuator 3 during the adjustment process.

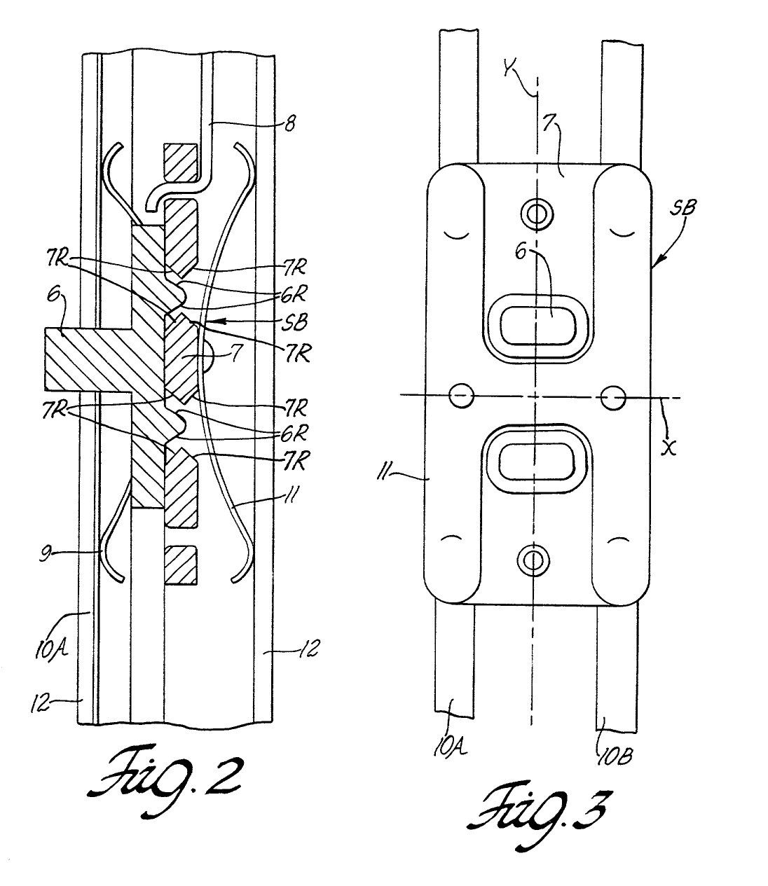

The switch is part of switch assembly A that comprises a shuttle 6 and a contact carrier 7 as best shown in FIGS. 2 and 3. The shuttle 6 slides to and fro inside the housing 12. During normal operation the contact carrier 7 moves along with the shuttle 6.

The shuttle 6 is connected to the nut N of the jack screw actuator 2 so that shuttle 6 travels the same distance as the nut N of the jack-screw actuator 2. This is the preferred method. However, contact shuttle 6 may be connected to the jack screw actuator 2 in any way that forces the shuttle 6 to travel the same distance as the output of the jack screw actuator 2.

The contact carrier 7 is driven through a push-pull cable 8 by the translatable nut N of the jack screw actuator 3. As in the case of shuttle 6, this is the preferred method. However, as before, contact carrier 7 may be connected to the jack screw actuator 3 in any way that forces the carrier 7 to travel the same distance as the nut N or the output of the jack screw actuator 3.

Attached to one side of the contact carrier 7 is a stamped metal contacting element 9 that rides along a pair of conductive contact rails 10A and 10B that are affixed to an inside surface of housing 12. Contacting element 9 electrically connects the two conductive contact rails 10A and 10B and is commonly referred to as a wiper.

The contacting element 9 is H-shaped in plan form and bow shaped in elevation providing four curved legs that are shaped to act as leaf springs. The spring force of the four leaf spring legs provides contact pressure between the contacting element 9 and the conductive contact rails 10A and 10B. The ends of the contacting element 9 are reversely curved with a much greater curvature than the bow shape of the main body of the contacting element which is curved in the opposite direction. This shape allows the contacting element 9 to ride freely on the laterally spaced surfaces of the respective conductive contact rails 10A and 10B.

For improved reliability, the contacting portion of element 9 has a pair of longitudinally spaced contacts for each rail 10A and 10B. This provides a total of four contacts. If the electrical connection between one of the contacts and a particular rail 10A or 10B momentarily fails the other contact maintains contact and conducts the current.

Switch assembly A further includes an H-shaped spring 11 in housing 12 that provides pressure for the contacting element 9 at the four interfaces with contract rails 10A and 10B. For the sake of common parts in switch assembly A, the shape of spring 11 and the contacting element 9 are identical. Carrier 7 is also preferably symmetrical. The identical shape of the contacting element 9 and spring 11 and the symmetrical shape of carrier 7 results in sub-assembly SB consisting of contacting element 9 and spring 11 attached to carrier 7 being a symmetrical part. In other words, the subassembly SB can be assembled to shuttle 6 and cable 8 as shown in FIG. 3 or subassembly SB can be rotated 180° about either or both the X-axis X and the Y-axis Y from the position shown in FIG. 3 before it is assembled to shuttle 6 and cable 8. This symmetry makes the assembly process easier.

The ends of the two contact rails 10A and 10B act as terminals of the switch assembly A by which the switch inside the housing 12 is wired in series with the electric motor 1 and a battery as shown in FIG. 4.

The adjustable pedal system operates as follows. The respective and aft positions of the pedals AC and BR are adjusted by a three way pedal adjustment switch 18 that is part of a motor control circuit 20 shown in FIG. 4. The three-way pedal adjustment switch 18 (which has forward; neutral and aft positions) is operated to energize electric motor 1 for rotation in one direction or the other. Electric motor 1 then drives jack screw actuators 2 and 3 via cables 4 and 5, FIG. 1, as indicated above. Jack screw actuators 2 and 3 in turn translate their respective nuts N forward or aft depending on the rotation of electric motor 1, to adjust the fore and aft position of pedals BR and AC. During normal operation, shuttle 6 and contact carrier 7 travel in unison with the contacting element 9 bridging the contact rails 10A and 10B which keeps the switch in switch assembly A (FIGS. 2, 3 and 4) closed thus maintaining the motor control circuit 20 closed during the adjustment process. However, during abnormal operation, such as when cable 5 breaks, the two jack screw actuators 2 and 3 get out of sync and their respective nuts N do not travel together. Due to the differing travel of the respective nuts N of jack screw actuators 2 and 3, the shuttle 6 moves with respect to the contact carrier 7 in one direction or the other.

The shuttle 6 and the contact carrier 7 both have cams or ramped surfaces 6R and 7R respectively as shown in FIG. 2. As the contact carrier 7 moves with respect to shuttle 6, ramped surfaces 7R contact ramped surfaces 6R and force the contact carrier 7 away from the shuttle 6 against the action of spring 11. This causes the contact element 9 to lift from the surfaces of the contact rails 10A and 10B. This opens the motor control circuit 20, stopping electric motor 1 and halting the pedal adjustment process. Thus pedals BR and AC are always maintained in substantial alignment. If desired a small misalignment can be tolerated by having lost motion between shuttle 6 and carrier 7 before ramped surfaces 6R and 7R engage as shown by the gaps between the ramped surfaces 6R and 7R in FIG. 2.

In the adjustable pedal system described above, the pedals BR and AC are pivotally mounted on the nuts N of the respective jack screws 2 and 3 by lever arms forming part of the respective pedal. However, the pedals can be immovable fixed to the nuts N depending on the mechanism that adjusts the positions of the pedals. See for instance, the Rixon '302 patent discussed above. In other words, although a preferred embodiment of the present invention has been disclosed, various changes and modifications may be made thereto by one skilled in the art without departing from the scope and spirit of the invention as set forth in the appended claims. It is also understood that the terms used herein are merely descriptive, rather than limiting, and that various changes may be made without departing from the scope and spirit of the invention.

1. An adjustable pedal system comprising,
a first pedal pivotally attached to a translatable nut of a first jack screw actuator for adjusting the fore and aft position of the first pedal,
a second pedal pivotally attached to a translatable nut of a second jack screw actuator for adjusting the fore and aft position of the second pedal,
an electric motor drivingly connected to the first jack screw actuator and the second jack screw actuator for driving the translatable nuts fore and aft, and
means to maintain the fore and aft position of the first pedal with respect to the position of the second pedal including a switch assembly.

2. The adjustable pedal system as defined in claim 1 wherein:
the switch assembly has a shuttle that is mechanically connected to one of the first and second jack screw actuators for concurrent movement therewith and a contact carrier that is mechanically connected to the other of the first and second jack screw actuators for concurrent movement therewith, and
the contact carrier carries a contacting element that opens and closes a motor control circuit for the electric motor.

3. The adjustable pedal system as defined in claim 2 wherein:
the shuttle and the contact carrier are disposed in a housing that has two internal contact rails,
the contacting element bridges the contact rails in the housing when the shuttle and the contact carrier travel together, and
the shuttle and the contact carrier have cams that contact and force the contact carrier and the contacting element away from the contact rails when the shuttle is displaced with respect to the contact carrier by a predetermined amount to open the motor control circuit when the translatable nuts are out of alignment by a predetermined distance.

4. The adjustable pedal system as defined in claim 3 wherein:
the contacting element is attached to one side of the contact carrier, and
the switch assembly includes a spring that is attached to an opposite side of the carrier.

5. The adjustable pedal system as defined in claim 4 wherein the contacting element has an H-shape and the spring has a shape that is identical to the H-shape of the contacting element.

6. The adjustable pedal system as defined in claim 5 wherein the contact carrier, the contacting element and the spring form a symmetrical sub-assembly.
